(19) United States
(12) Patent Application Publication
(10) Pub. No.: US 2018/0292884 A1
(43) Pub. Date: Oct. 11, 2018

(54) ELECTRONIC SYSTEM AND CONTROL METHOD

(71) Applicant: Acer Incorporated, New Taipei City (TW)

(72) Inventors: Chien-Ting Chiu, New Taipei City (TW); Yu-Liang Chiu, New Taipei City (TW); Sun-Chung Chou, New Taipei City (TW)

(21) Appl. No.: 15/627,522

(22) Filed: Jun. 20, 2017

(30) Foreign Application Priority Data
Apr. 7, 2017 (TW) 106111630

(51) Int. Cl. G06F 1/32; G06F 9/44

(52) U.S. Cl. CPC G06F 1/3287; G06F 9/442; G06F 1/3265; G06F 9/4401

(57) ABSTRACT

An electronic system is provided. The electronic system includes a display device including a switch module for generating a control signal, and a first video port for transmitting the control signal; and a host device including a second video port, for receiving the control signal, and a controller, responsive to the control signal, for determining whether to control the host device to perform one of a wake up process or perform a boot process.

This application claims the benefit of Taiwan Application Serial No. 106111630, filed Apr. 7, 2017, the subject matter of which is incorporated herein by reference.

### TECHNICAL FIELD

Embodiments of the present invention are directed to remote triggering of a wake up or boot process.

### BACKGROUND

As the field of information technology continues to grow, so does the interaction of people and computer systems. Real-time network communications, e-mail communications, a variety of information querying applications, along with multimedia applications, are all commonly used in both home and office settings. In general, when a user wants to start an electronic device that supports such communications and applications, the user must press a power button of the electronic device to carry out the relevant boot program. For example, in the case of a desktop computer, the location of the power key or button is usually disposed on the host. However, due to environmental factors, the host may be placed at a distance from where a user might be located. As such, when the user wants to start the computer, he may need to leave his seat to press the power button on the host computer. And, when the host is placed in a more secluded place, such as under a desk or in a cabinet, it may be even more inconvenient for a user to find the power button and press it.

### SUMMARY

In one embodiment, an electronic system is provided and includes a display device comprising a switch module for generating a control signal, and a first video port for transmitting the control signal; a host device comprising a second video port for receiving the control signal; and a controller, in communication with the second video port and responsive to the control signal, for determining whether to control the host device to perform one of a wake up process or a boot process.

In another embodiment, a method comprises receiving, from a video port of a display device, via a video port of a host device, a control signal from the display device; and controlling the host device to perform one of a wake up process or a boot process, responsive to the control signal.

The embodiments described herein enable a user to easily wake-up or boot a host device by operating, e.g., a power button of a display device, which connected to the host device. A control signal for causing the host device execute a wakeup or boot process is communicated to the host device from the display device via respective video ports.

### BRIEF DESCRIPTION OF THE DRAWINGS

Embodiments are described herein in conjunction with the accompanying drawings, in which:

FIG. 1 is a schematic view of an electronic system according to an embodiment of the present invention;

FIG. 2 shows a display device and host device in communication with one another according to an embodiment of the present invention; and

FIG. 3 is a schematic view of an embodiment of a switch module according to an embodiment of the present invention.

### DESCRIPTION OF EXAMPLE EMBODIMENTS

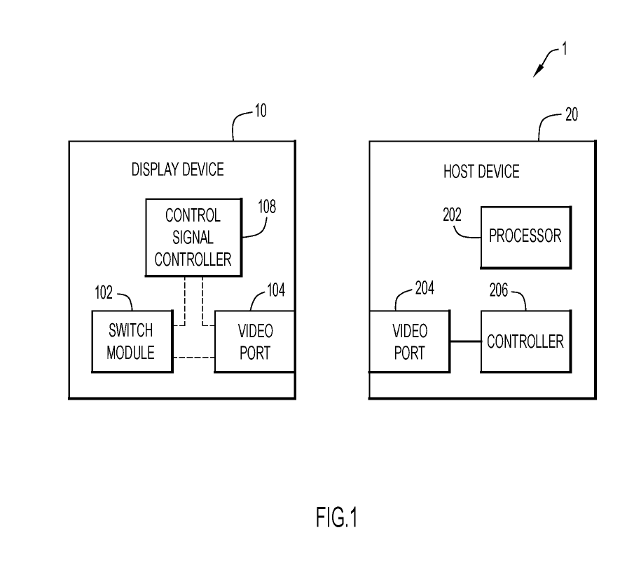

FIG. 1 is a schematic view of an electronic system 1 according to an embodiment of the present invention. The electronic system 1 may be a desktop computer, an electronic industrial system, a smart television, or other electronic system equipped with a display device. The electronic system 1 includes a display device 10 and a host device 20. The display device 10 includes, for purposes of the instant description, a switch module 102 and a video port 104. The display device 10 may also include a control signal controller 108. The host device 20 includes, for purposes of this description, a processor 202, a controller 204, and a video port 206. The processor 202 and or controller 204 may be an embedded controller (EC) or a Keyboard Controller (KBC), but is not limited thereto. The host device 20 may transmit a video signal to the video port 104 via video port 206 to provide a video signal to the display device 10, and, in turn, the display device 10 may display video according to the video signal.

In accordance with an embodiment of the present invention, when there is a need to wake up or boot/start the host device 20, rather than accessing the host device directly, the user can operate the switch module 102 of the display device 10 (e.g., its power button) to generate a control signal that causes the host device 20 to wake or boot. The control signal generated by the display device 10 is transmitted to the host device 20 via the video port 104 and the video port 206. Upon receiving the control signal, the controller 204 may decide to control the host device 10 to execute a wake-up program or a boot program. In sum, and at a high level, the present invention enables a user to use the switch (e.g., a power switch) on a display device to start or wakeup a host device to which it is connected via a control signal communicated via respective video ports.

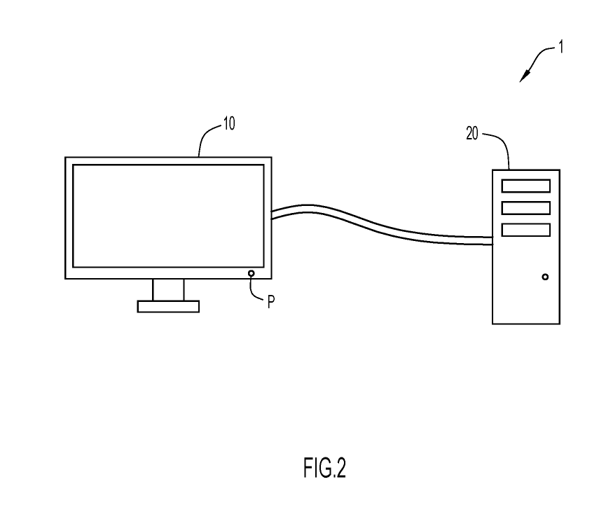

FIG. 2 shows the display device 10 and the host device 20 in communication with one another in the overall electronic system 1 according to an embodiment of the present invention. Although not depicted, it is assumed that the display device 10 of the electronic system 1 is placed in front of (i.e., near) the user and the host device 20 is placed at a distance from the user, such that it may be inconvenient for the user to reach or access the host device 20. The switch module 102 includes a power button P for the display device 10. In accordance with an embodiment, when the user presses the power button P of the display device 10, the display device 10 generates a control signal and transmits the control signal to the host device 20 through the video port 104 and the video port 206.

When the host device 20 receives the control signal, the controller 204 detects/determines the current system state of the host device 10 to decide how to respond to the control signal. For example, when the detection result indicates that the current system state of the host device 10 is in a shutdown state (for example, as shown in Table 1, the Advanced Configuration and Power Interface (ACPI) G3 state, or S5 state), the controller 204 may execute a power-on program by controlling the host device 10 to cause the host device 20 to enter a normal operating state (e.g., S0 state of ACPI). More specifically, when the host device 10 receives the control signal and the current system state is in an off state, the controller 204 may cause the host device to execute a boot program or process (as indicated in Table 1). Next, the processor 202 may load the basic input/output system (not shown in the figure) of the host device 20 into system memory of the host device 10 (not shown in the figure) to enable the host device 20 to enter into the normal operating state.

In another embodiment, when the detection result indicates that the current system state of the host device 20 is in a standby or sleep state (for example, the S3 state or the S4 state of the ACPI), the controller 204 may control the host device 20 to execute a wake-up program, causing the host device 20 to enter a normal operating state (e.g., S0 state of ACPI).

In yet another embodiment, and as further shown in Table 1, the controller 204 does not perform any operation when the detection result indicates that the current system state of the host device 20 is in the normal operating state (e.g., S0 state of ACPI). That is, when the current system state of the host device 20 is in the normal operating state, the controller 204 can ignore the control signal transmitted by the display device 10 without executing the wake-up program or the power-on program.

In sum, the present invention generates a control signal by means of a switch on the display device 10 and the controller 204 can decide whether to control the host device 20 to execute a wake up program or a boot program based on the control signal and the current system state after the host device 20 receives the control signal. Thus, the instant embodiments provide a user with a more convenient and simple way to start and wake up a host device. That is, a user need not separately and directly control the host device 20 by way of its power switch or button.

TABLE 1

| Current system state of host device 10 | Action |
|---|---|
| S0 (normal operation) | None |
| S3 (standby) | Execute wake-up program |
| S4 (standby) | Execute wake-up program |
| S5 (shut down) | Execute boot process |
| G3→S5 (shut down) | Execute boot process |

Additional functionality, beyond generating and sending the control signal may be provided by the display device 10. This functionality may be provided via an optional control signal controller 108 (e.g., an embedded controller), as shown in FIG. 1. As shown in FIG. 2, the power button P of the display device 10 is used as the power button for the display device 10 itself, and operation/activation of the power button P may also, as explained, trigger generation and transmission of the control signal, which in turn will cause a wake up or boot process in the host device 20. In an embodiment, when the power button P is pressed to generate the control signal, the display device 10 may further control whether the control signal is transmitted to the host device 20 or not.

More specifically, and as explained above, when the user presses the power button P, the display device 10 may be switched from a shutdown state to a normal operation state. At the same time, the display device 10 also generates the control signal. Then, the display device 10 transmits the control signal to the host device 20 to cause a wake-up or boot program to execute. That is, the display device 10 allows the generated control signal to be transmitted to the video port 206 of the host device 20 when the user presses the power button P after the display device 10 is switched to a normal operation state to display video.

In another embodiment, the generated control signal may not be sent to the host device 20. That is, the display device 10 may prohibit transmission of the control signal generated by the display device 10 to the host device 20 when the display device 10 is switched to the OFF state after the user presses the power button P. In this way, the host device 20 is not affected by the control signal generated by the display device 10. That is, when the display device 10 is turned off, the host device 20 may remain operational, at least until it enters a sleep state, for example.

TABLE 2

| State of display device 10 | Action |
|---|---|
| Shutdown State --> Normal | Allow transmission of control signal |
| Operating State | to the host device 20 |
| Standby state --> Normal | Allow transmission of control signal |
| operating state | to host device 20 |
| Standby state --> Shutdown | Prohibit transmission of control signal |
| state | to host device 20 |
| Normal working | Prohibit transmission of control signal |
| state --> Shutdown | to host device 20 |
| state | |

As shown in Table 2, only when the display device 10 is transitioning from a shutdown or standby state does the display device 10 send the control signal. If, by activation of the power button P on the display device 10, the display device 10 is to transition to a shutdown state, the control signal is prohibited from being sent to the host device 20.

In yet another embodiment, and with reference to Table 3, when the user presses the power button P, the display device 10 switches from the normal operation state (or standby state) to the shutdown state and generates the control signal. In this case, the control signal is communicated to the host device 20 via the video port 104 and the video port 206. That is, when the display device 10 is switched from the normal operation state (or standby state) to the shutdown operation state in response to operation of the power button P, the display device 10 allows the control signal generated by the display device 10 to be transmitted to the host device 20. The host device 20 may then perform an action according to a setting (e.g., a firmware setting) of the controller 204.

For example, after the host device 20 receives the control signal, the controller 204 may be configured to not perform control operations on the host device 20. That is, the controller 204 may ignore the control signal transmitted by the display device 10 without executing the wake-up program or the power-on (boot) program such that the host device 20 is not affected by the control signal generated by the display device 10.

TABLE 3

| State of display device 10 | Action |
|---|---|
| Standby state → Shutdown | Allow transmission of a control signal |
| state | to the host device 20 and perform an |
| | operation according to a setting of the |
| | controller 204 |
| Normal working | Allow transmission of a control signal |
| state → Shutdown | to the host device 20 and perform an |
| state | operation according to a setting of the |
| | controller 204. |

Reference is again made to FIG. 1. As shown, the video port 104 and the video port 206 may be connected together via a transmission cable, a connector, or other wired or wireless means. Video port 104 and video port 206 may be compatible with, e.g., video graphics array (VGA, also known as D-sub), high-definition multimedia interface (HDMI), digital video interface (DVI), Display Port (DP) or any other video interface standard. In accordance with an embodiment, an undefined or no-connect (NC), or ground, pin of a given physical video port may be used to send the control signal from the display device 10 to the host device 20 so as to avoid a conflict with other data being passed via the video port. For example, if the video port 104 and the video port 206 conform to the video graphics array (VGA) interface standard, VGA pin-4 may be selected for transmission of the control signal. As another example, if the video port 104 and the video port 206 conform to the HDMI standard, pin 14 may be selected for transmission of the control signal. As still another example, if the video port 104 and the video port 206 conform to the DVI standard, pin-8 may be selected for transmission of the control signal. As yet another example, if the video port 104 and the video port 206 conform to the DP interface standard, pin 16 may be selected for transmission of the control signal.

Further, the controller 204 may be connected to the video port 206 through its own, e.g., general purpose input output (GPIO) to receive the control signal. Preferably, the pins of the general-purpose input/output port of the controller 204 may be set using the basic input/output system of, e.g., Windows Management Instrumentation (WMI) of the host device 20, or the operating system of the host device 20 to enable the controller to receive the control signal.

The switch module 102 may comprise, for example, but is not limited to, a key switch, a slide switch, a rotary switch, or other mechanical switch. The switch module 102 may also be implemented as (but is not limited to) a touch switch.

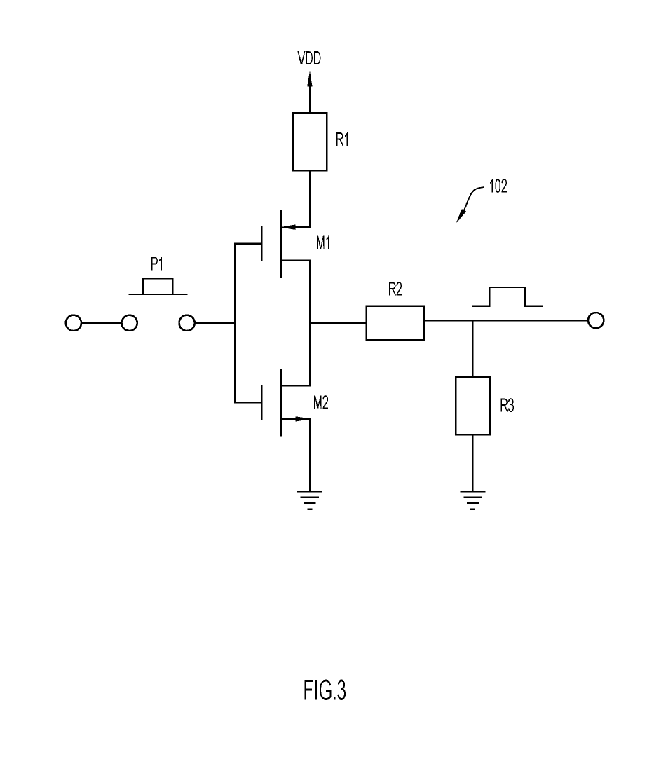

FIG. 3 is a schematic view of an embodiment of the switch module 102. As shown, the switch module 102 includes the key or button P1, transistors M1 and M2, and resistors R1, R2 and R3. The key P1 may be, but is not limited to, the power button of the display device 10. When the user presses the key P1, the control signal is generated, and is shown as a square wave pulse in FIG. 3. The control signal may then be communicated via a given pin of the video port 104 to the video port 206 of the host device 20. In one possible implementation, resistors R2 and R3 are 1 kilo Ohm (kΩ) and 100 kΩ, respectively. The source of transistor M1 is coupled to a voltage source VDD of 3.3 volts. When the user presses the key P1, the switch module 102 may generate a pulse signal of a predetermined time, for example, a pulse wave signal having a pulse width of, e.g., 200 milliseconds (ms). The pulse signal (i.e., the control signal) is then transmitted to the host device 20 via the video port 104 and the video port 206 so that the host device 20 can execute a wake up or boot program, or ignore the control signal, as the case may be.

Those skilled in the art will appreciate that the present invention allows a user to use the switch of a display device to facilitate a remote and simple way to start and wake up the host device.

The above description is intended by way of example only.

What is claimed is:

1. An electronic system, comprising:
a display device comprising a switch module for generating a control signal, and a first video port for transmitting the control signal;
a host device comprising a second video port for receiving the control signal; and
a controller, in communication with the second video port and responsive to the control signal, for determining whether to control the host device to perform one of a wake up process or a boot process.

2. The electronic system of claim 1, wherein the control signal is a pulse wave signal.

3. The electronic system of claim 2, wherein a period of the pulse wave is about 200 milliseconds.

4. The electronic system, of claim 1, wherein the controller, responsive to the control signal, takes no action when the host device is in a normal operating state, executes the wake-up program when the host device is in a standby state, or executes the boot process when the host device is in a shut-down state.

5. The electronic system of claim 1, wherein the display device further comprises a control signal controller, responsive to an operational state of the display device, that is configured to allow or prohibit the control signal from being transmitted from the first video port.

6. The electronic system of claim 5, wherein the control signal controller allows the control signal to be transmitted from the first video port when the display device is being transitioned from one of a shutdown state or a standby state to a normal operating state.

7. The electronic system of claim 5, wherein the control signal controller prohibits the control signal to be transmitted from the first video port when the display device is being transitioned from one of a standby state or a normal operating state to a shutdown state.

8. The electronic system of claim 1, wherein the display device comprises a power button, and the switch module is configured to generate the control signal in response to an operation of the power button.

9. The electronic system of claim 1, wherein the controller of the host device is configured to ignore the control signal when the display device is being transitioned from one of a standby state or a normal operating state to a shutdown state.

10. The electronic device of claim 1, wherein the first video port and the second video port comply with one of the video graphics array (VGA), high-definition multimedia interface (HDMI), digital video interface (DVI), or Display Port (DP) interface standards.

11. A method, comprising:
receiving, from a video port of a display device, via a video port of a host device, a control signal from the display device; and
controlling the host device to perform one of a wake up process or a boot process, responsive to the control signal.

12. The method of claim 11, wherein the control signal is a pulse wave signal.

13. The method of claim 12, wherein a period of the pulse wave is about 200 milliseconds.

14. The method of claim 11, further comprising taking no action when the host device is in a normal operating state, executing the wake-up program when the host device is in a standby state, or executing the boot process when the host device is in a shut down state.

15. The method of claim 11, further comprising, at the display device, controlling whether to allow or prohibit the control signal from being transmitted to the host device.

16. The method of claim 15, further comprising allowing the control signal to be transmitted to the host device when the display device is being transitioned from one of a shutdown state or a standby state to a normal operating state.

17. The method of claim 15, further comprising prohibiting the control signal to be transmitted to the host device when the display device is being transitioned from one of a standby state or a normal operating state to a shutdown state.

18. The method of claim 11, wherein the display device comprises a power button, and the method further comprises generating the control signal in response to an operation of the power button.

19. The method of claim 11, further comprising ignoring the control signal when the display device is being transitioned from one of a standby state or a normal operating state to a shutdown state.

20. The method of claim 11, wherein the video port of the display device and the video port of the host device comply with one of the video graphics array (VGA), high-definition multimedia interface (HDMI), digital video interface (DVI), or Display Port (DP) interface standards.
